(19) United States
(12) Patent Application Publication
(10) Pub. No.: US 2025/0377501 A1
(43) Pub. Date: Dec. 11, 2025

(54) FIBER CONNECTOR LOCK

(71) Applicant: Government of the United States of America, as represented by the Secretary of Commerce, Gaithersburg, MD (US)

(72) Inventors: Joshua Aram Hadler, Lyons, CO (US); Kyle Andrew Rogers, Superior, CO (US)

(21) Appl. No.: 19/228,967

(22) Filed: Jun. 5, 2025

Related U.S. Application Data
(60) Provisional application No. 63/657,149, filed on Jun. 7, 2024.

(51) Int. Cl. G02B 6/255

(52) U.S. Cl. CPC G02B 6/2555

(57) ABSTRACT

FC style connectors do not afford a secondary engineering control that would prevent the removal of the connector. Exemplary locks include a first lock portion; and a second lock portion. The first and second lock portions are configured to fit over a fiber connector, and wherein the first and second lock portions are selectably rigidly fixable to each other. Exemplary embodiments allow for the locking of potentially hazardous, or critical systems, to prevent inadvertent disconnection.

### RELATED APPLICATIONS

This application claims the benefit of U.S. Provisional Patent Application Ser. No. 63/657,149 (filed Jun. 7, 2024), which is herein incorporated by reference in its entirety.

### FEDERALLY-SPONSORED RESEARCH AND DEVELOPMENT

This invention was made with United States Government support from the National Institute of Standards and Technology (NIST), an agency of the United States Department of Commerce. The Government has certain rights in this invention.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF INVENTION

The present invention relates generally to fiber optics, and more particularly to a fiber connector lock to increase safety and/or security.

### BACKGROUND

Fiber optics in research, development and testing environments conventionally use FC (acronym for “ferrule connector” or “fiber channel”) style connectors which provide reliability and ease of use. The fiber end of the FC style connector is embedded in a ferrule made of zirconia ceramic or stainless steel. The tip is then typically polished to produce a rounded surface. This surface profile means that when the fibers are mated, they touch only at their cores, allowing transmission with low loss. The fibers are spring-loaded to control the force as the plug is screwed into the receptacle. A key prevents the fiber from rotating while the connectors are being mated.

### SUMMARY OF INVENTION

However, there are times where potentially hazardous laser emissions can be present in the fiber. The FC style connector is manually threaded into place, which does not afford a secondary engineering control that would prevent the removal of the connector. Exemplary locks provide an easy and affordable control that requires the use a tool to access the connector without the need to retrofit the instrumentation or hardware involved. Exemplary embodiments can be used on any existing FC style connector. Furthermore, other exemplary embodiments can also be used for BNC style electrical connections or other manual twist-to-connect-style connectors as well. Exemplary embodiments allow for the locking of potentially hazardous, or critical systems, to prevent inadvertent disconnection.

According to an aspect of the invention, a fiber connector lock assembly includes a first lock portion; a second lock portion; wherein the first and second lock portions are configured to fit over a fiber connector, and wherein the first and second lock portions are selectably rigidly fixable to each other.

Optionally, the first and second lock portions each include a respective body portion extending partially circumferentially around a central axis and a respective fastener portion extending laterally outwardly from the body portion.

Optionally, the first and second lock portions each include a respective fastener hole extending through a respective fastener portion.

Optionally, the respective fastener holes each extend perpendicularly to and skew with the central axis, and wherein the fastener hole of the first lock portion aligns with the fastener hole of the second lock portion when the lock portions are aligned around the central axis.

Optionally, the respective body portions each extend longitudinally along the central axis for a length sufficient to substantially or fully cover a rotatable connecting portion of an FC connector when the fiber connector lock assembly is fastened on an FC connector.

Optionally, the first and second lock portions are lock halves.

Optionally, the first and second lock portions are independent of each other.

Optionally, the first and second lock portions are flexibly attached to each other.

Optionally, the first and second lock portions are selectably fixable to each other by a latch and catch mechanism, wherein the first lock portion includes a latch, and the second portion includes a catch configured to selectably mate with the latch.

Optionally, the first and second lock portions are configured to accept and be selectably fixed to each other by a mechanical fastener.

Optionally, the first lock portion includes front and rear shroud portions that extend radially inwardly from the body portion a sufficient length to longitudinally fix the portion with respect to an FC connector when fastened thereon.

Optionally, the longitudinal fix is a slip fit.

Optionally, the second lock portion includes front and rear shroud portions that extend radially inwardly from the body portion a sufficient length to longitudinally fix the portion with respect to an FC connector when fastened thereon, wherein the shroud portions of the lock portions are generally annular in shape, and wherein longitudinally inward faces of the shroud portions and radially inward faces of the body portions define a cavity therebetween, the cavity having a radius marginally larger than that of an FC connector, such that turning of the fiber connector lock assembly about its central axis does not cause turning of an FC connector therein.

Optionally, the first and second lock portions are connected by a flexible hinge.

Optionally, the flexible hinge, the first lock portion, and the second lock portion are all a single, monolithic piece.

The foregoing and other features of the invention are hereinafter described in greater detail with reference to the accompanying drawings.

### BRIEF DESCRIPTION OF THE DRAWINGS

FIG. 1 shows an isometric view of an exemplary fiber connector lock assembly.

FIG. 2 shows a front view of an exemplary fiber connector lock assembly.

FIG. 3 shows an exploded isometric view of an exemplary fiber connector lock assembly.

FIG. 4 shows an isometric view of an exemplary fiber connector lock half.

FIG. 5 shows another isometric view of an exemplary fiber connector lock half.

FIG. 6 shows a front view of an exemplary fiber connector lock half.

FIG. 7 shows a top view of an exemplary fiber connector lock half.

FIG. 8 shows a bottom view of an exemplary fiber connector lock half.

FIG. 9 shows a side view of an exemplary fiber connector lock half.

FIG. 10 shows another side view of an exemplary fiber connector lock half.

FIG. 11 shows a top view of a conventional FC connector with an exemplary fiber connector lock half shown positioned along the bottom of the FC connector.

### DETAILED DESCRIPTION

FC connector locks in accordance with the invention provide the ability to install a secondary control on FC fiber optic connectors, preventing them from being disconnected or accessed without the use of a tool. The ability to control the connector can be essential when the fiber optic is carrying potentially hazardous laser emissions, or if maintaining the fiber optic connection at all times is critical for the operation of the system(s) involved. This has broad implications in the research, development, and testing environments where the FC connector is the industry standard and is in widespread use worldwide.

Exemplary FC connector locks close around the FC connector in a clam-shell fashion and may be secured by use of a fastener, which can be, for example, a standard socket cap screw, torx, or even a security head screw if desired. Once closed around the connector and fastened, the knurled shell of the FC connector itself cannot be gripped in order to unthread the connector from the bulkhead it's fastened to. Installation in-situ is also possible, which can benefit systems which cannot afford disruption or disconnection.

It is contemplated that the invention is extendable for use with other manually operated rotating shell connectors in a similar fashion, providing an engineering control to prevent disconnection rather than solely relying on working practices and procedures to prevent inadvertent or unplanned disconnection of potentially hazardous or critical connections. As previously noted, the device can also be adapted for use with BNC style electrical connections or other manual twist-to-connect-style connectors.

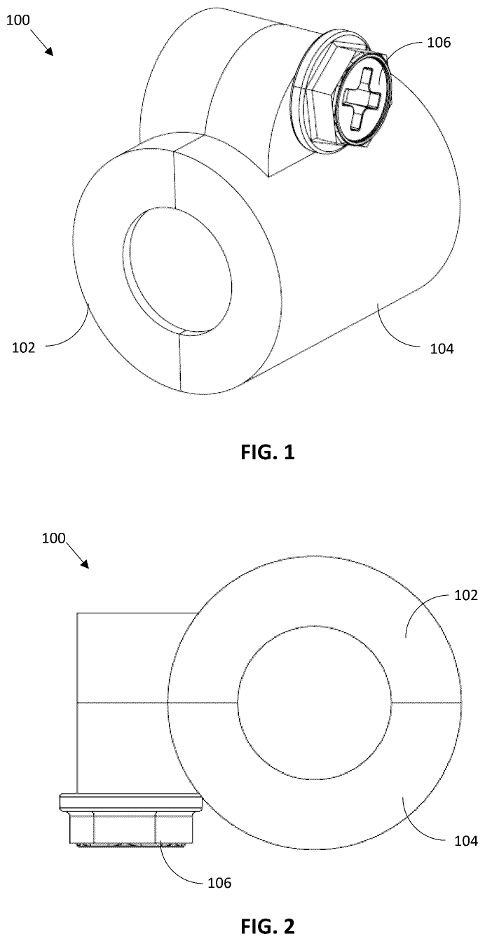

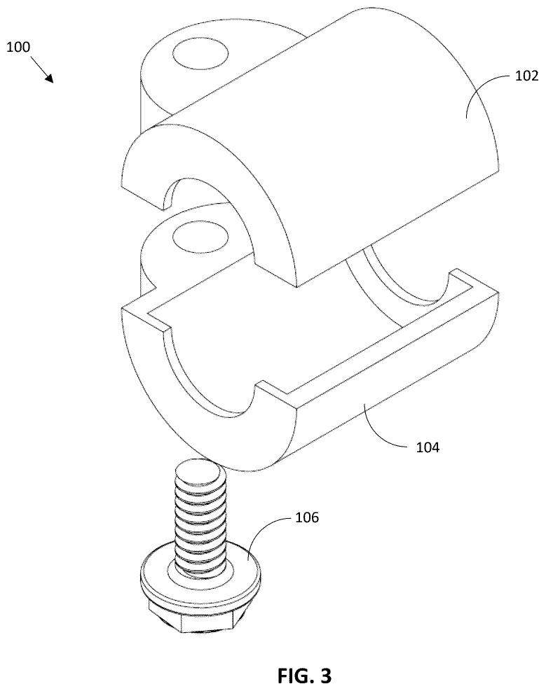

Referring now to FIGS. 1-3, an exemplary fiber connector lock assembly 100 is shown. The fiber connector lock assembly may include two lock portions 102, 104, shown here as lock halves. The lock portions 102, 104 need not be symmetric as shown. Rather, any relative proportions that allow for the portions 102, 104 to fit over the fiber connector is contemplated. The portions 102, 104 may be independent of each other or may be attached (either as a monolithic structure or composite structure), for example by a thin flexible portion of material, preferably of the same material as the body of the portions to allow for ease of manufacture, whether by additive manufacturing, injection molding, or the like. The portions 102, 104 may be selectably fixed to each other by, for example, a snap-fit or via a separate mechanical fastener (such as a screw or bolt and nut) 106, as illustrated.

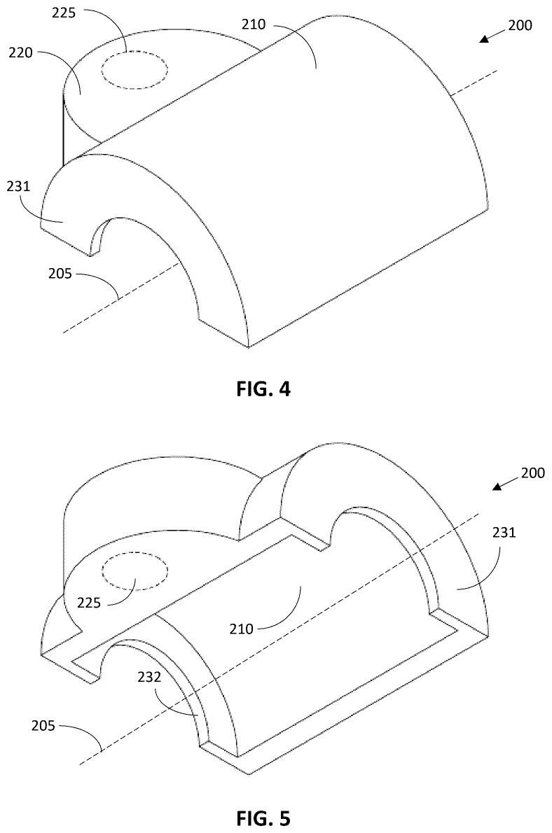

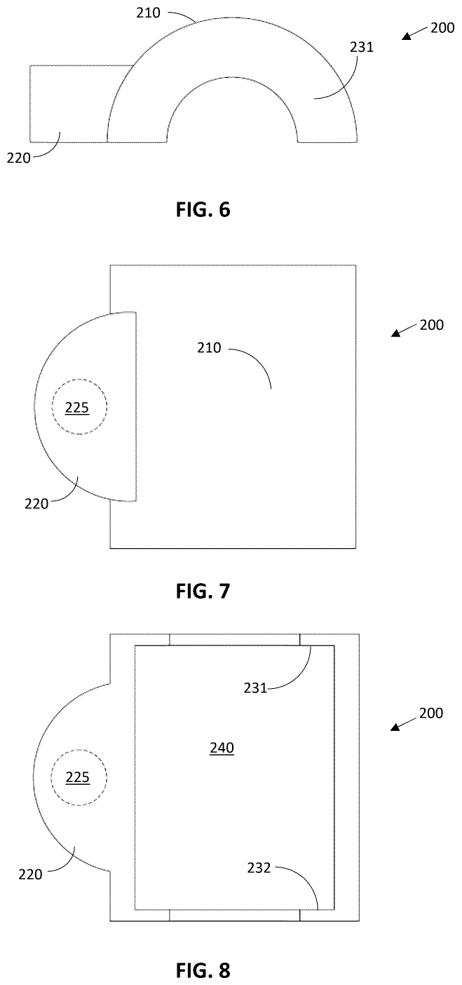

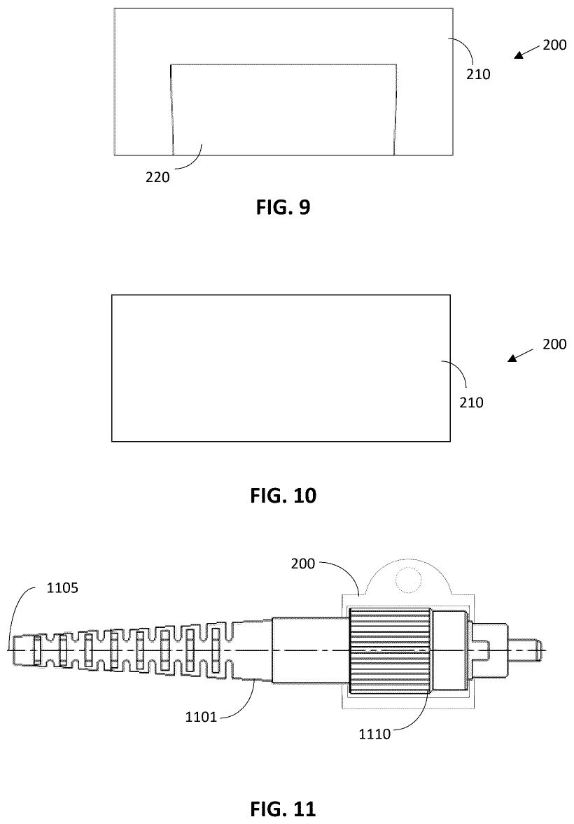

Referring now to FIGS. 4-11, an exemplary fiber connector lock portion (here, half) 200 is shown in isometric and orthographic views. The connector lock portion 200 includes a body portion 210 extending partially circumferentially (in this case, halfway) around a central axis 205 and a fastener portion 220 extending laterally (preferably radially) outwardly from the body portion 210. The fastener hole 225 extending through the fastener portion 220 is shown in broken lines and is not part of any ornamental design of the lock half 200. Preferably, the fastener hole 225 extends perpendicularly to and skew with the central axis 205. Preferably, the fastener hole 225 aligns with a like fastener hole or mating fastener of a corresponding second connector lock portion (not shown). The central axis 205 preferably aligns with a central axis 1105 of an FC connector 1101, as shown in FIG. 11. The body portion 210 preferably extends longitudinally along the central axis 205 for a length sufficient to substantially or fully cover a rotatable connecting portion 1110 of an FC connector 1101 when fastened on an FC connector. Preferably, the connector 200 includes front and rear shroud portions 231, 232 that extend radially inwardly from the body portion 210 a sufficient length to longitudinally fix the lock portion 200 with respect to an FC connector 1101 when fastened thereon, preferably with enough slippage or tolerance to form a slip rather than interference fit with an FC connector therebetween. Shroud portions may be generally annular in shape. A cavity 240 may be formed and defined by shroud portions 231, 232 and body portion 210. The cavity 240 preferably has a radius larger than that of an FC connector, such that turning of a lock 200 about its central axis 205 does not cause turning of an FC connector therein.

Exemplary connector locks may be made by a variety of methods including 3D-printing, injection molding, and/or machining processes. Exemplary connector locks may be monolithic or made of more than one piece and can be manufactured out of a variety of materials including soft metals, plastics, composites or natural materials like wood. Exemplary connector locks are shown here to be two symmetrical parts such that manufacturing via injection molding may be simplified to require only a single mold cavity. Exemplary connector locks may also include embossment for laser hazard signage, or specific use signage to indicate function of a connected system, such as an arrow indicating the ingress/egress nature of the light.

In one embodiment, the dimensions of the fastener embossment allow for a single fastener to be used in a secure fashion. Any form of fastener may be used, including an embodiment utilizing clips to fasten two halves together to reduce parts needed. Exemplary connector locks are intended to be manufactured using materials that can be easily threaded should a fastener be used.

Other embodiments of the FC connector lock include but are not limited to connector locks for other styles of rotational connector (e.g., BNC, ST fiber connectors), a wider and more square connector lock for other telecom connector styles (e.g., LC, E-2000), custom embossed locks with instructional and safety purpose, or longer and broader locks for high-energy electrical connections.

Unlike conventional locking mechanisms, exemplary embodiments of an FC connector lock do not require the retrofitting or replacing of any hardware and can be installed in-situ. This allows existing systems to not only add a desired engineering control but can be installed without disruption of existing operations. Additionally, exemplary FC connector locks can be produced at a fraction the cost of conventional locking systems. Many scientific systems are constantly functioning and cannot afford disconnections to install engineering controls, or significant laser safety hazards exist upon disconnection of fibers.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix(s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A fiber connector lock assembly comprising:
a first lock portion; and
a second lock portion;
wherein the first and second lock portions are configured to fit over a fiber connector, and
wherein the first and second lock portions are selectably rigidly fixable to each other.

2. The fiber connector lock assembly of claim 1, wherein the first and second lock portions each include a respective body portion extending partially circumferentially around a central axis and a respective fastener portion extending laterally outwardly from the body portion.

3. The fiber connector lock assembly of claim 2, wherein the first and second lock portions each include a respective fastener hole extending through a respective fastener portion.

4. The fiber connector lock assembly of claim 3, wherein the respective fastener holes each extend perpendicularly to and skew with the central axis, and wherein the fastener hole of the first lock portion aligns with the fastener hole of the second lock portion when the lock portions are aligned around the central axis.

5. The fiber connector lock assembly of claim 2, wherein the respective body portions each extend longitudinally along the central axis for a length sufficient to substantially or fully cover a rotatable connecting portion of an FC connector when the fiber connector lock assembly is fastened on an FC connector.

6. The fiber connector lock assembly of claim 1, wherein the first and second lock portions are lock halves.

7. The fiber connector lock assembly of claim 1, wherein the first and second lock portions are independent of each other.

8. The fiber connector lock assembly of claim 1, wherein the first and second lock portions are flexibly attached to each other.

9. The fiber connector lock assembly of claim 1, wherein the first and second lock portions are selectably fixable to each other by a latch and catch mechanism, wherein the first lock portion includes a latch and the second portion includes a catch configured to selectably mate with the latch.

10. The fiber connector lock assembly of claim 1, wherein the first and second lock portions are configured to accept and be selectably fixed to each other by a mechanical fastener.

11. The fiber connector lock assembly of claim 1, wherein the first lock portion includes front and rear shroud portions that extend radially inwardly from the body portion a sufficient length to longitudinally fix the portion with respect to an FC connector when fastened thereon.

12. The fiber connector lock assembly of claim 11, wherein the longitudinal fix is a slip fit.

13. The fiber connector lock assembly of claim 11, wherein the second lock portion includes front and rear shroud portions that extend radially inwardly from the body portion a sufficient length to longitudinally fix the portion with respect to an FC connector when fastened thereon,
wherein the shroud portions of the lock portions are generally annular in shape, and
wherein longitudinally inward faces of the shroud portions and radially inward faces of the body portions define a cavity therebetween, the cavity having a radius marginally larger than that of an FC connector, such that turning of the fiber connector lock assembly about its central axis does not cause turning of an FC connector therein.

14. The fiber connector lock assembly of claim 1, wherein the first and second lock portions are connected by a flexible hinge.

15. The fiber connector lock assembly of claim 14, wherein the flexible hinge, the first lock portion, and the second lock portion are all a single, monolithic piece.
